(19) United States
(12) Patent Application Publication
(10) Pub. No.: US 2009/0277044 A1
(43) Pub. Date: Nov. 12, 2009

(54) Shoe

(75) Inventors: Savino Bove, Treviso (IT); Mikal Peveto, Treviso (IT); Conrad Piscioneri, Treviso (IT)

Correspondence Address: OBLON, SPIVAK, MCCLELLAND MAIER & NEUSTADT, L.L.P., 1940 DUKE STREET, ALEXANDRIA, VA, 22314, US

(73) Assignee: FILA LUXEMBOURG S.A.R.L., LUXEMBOURG (LU)

(21) Appl. No.: 11/658,146

(22) PCT Filed: Jan. 11, 2006
(86) PCT No.: PCT/IT06/00011

§ 371 Date: Jan. 23, 2007

(51) Int. Cl. A43B 5/00; A43B 13/14; A43B 23/00; B32B 5/16; C04B 35/00; C08J 5/14

(52) U.S. Cl. 36/114; 36/25 R; 36/45; 428/402; 501/134; 523/150

(57) ABSTRACT

A shoe (1), in particular a sports shoe, comprising a vamp (2) and a sole (3), said vamp (2) presenting side portions (4, 5), a front portion (7), a rear portion (6) and a portion (8) arranged to lie on the front part of the foot of a user wearing the shoe (1), the sole (3) presenting a metatarsal front portion (10), an arched central portion (11), and a rear heel portion (12). At least one among said vamp (2) and said sole (3) presents a part comprising a very hard ceramic material able to confer on said part a high wear resistance and hence a long life. This material is ceramic.

The present invention relates to a shoe in accordance with the introduction to the main claim.

With particular but not exclusive reference to sports shoes, a shoe of the stated type comprises a vamp and a sole, said vamp presenting side portions, a rear portion, a front portion and an upper portion (this latter superposed on a front-upper part of the foot of the user wearing the shoe); the sole comprises a metatarsal front part, an arched central part and a rear heel part.

Said parts of the shoe (and in particular the sole) are made of generally wear-resistant materials. However, particularly in sports shoes, there is the problem that their intense use on irregular or disjointed surfaces (such as those encountered in high-altitude trekking) can lead to deterioration of the sole and vamp. In particular, this latter presents more exposed parts (such as the side and front portions) which can be easily damaged by impact against high-resistance surfaces or can split when making contact with such surfaces or with bodies of irregular shape such as stones present on the ground along which the user wearing the shoe moves.

An object of the invention is to provide an improved shoe which presents a high resistance to wear, at least in certain of its most improved parts, and is hence of long life.

A particular object of the present invention is to provide a shoe in which at least those portions of its vamp which are most subject to wear or are most exposed to contact with obstructions have improved resistance to abrasion, so increasing their life.

Another object is to provide an improved shoe of the stated type which is of simple production and obtainable with minimum modifications to those production operations currently used to produce commercially available shoes.

Another object is to provide a shoe of the stated type which is of low cost. These and further objects which will be apparent to the expert of the art are attained by a shoe in accordance with the accompanying claims.

The present invention will be more apparent from the accompanying drawings, which are provided by way of non-limiting example and in which:

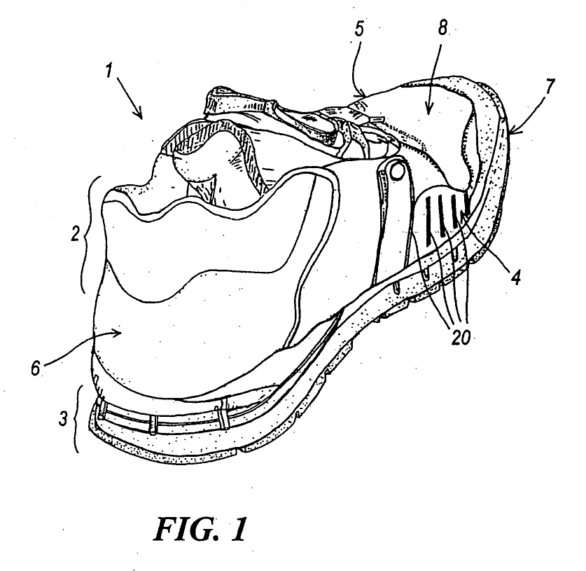

FIG. 1 is a perspective view of a shoe obtained in accordance with the invention;

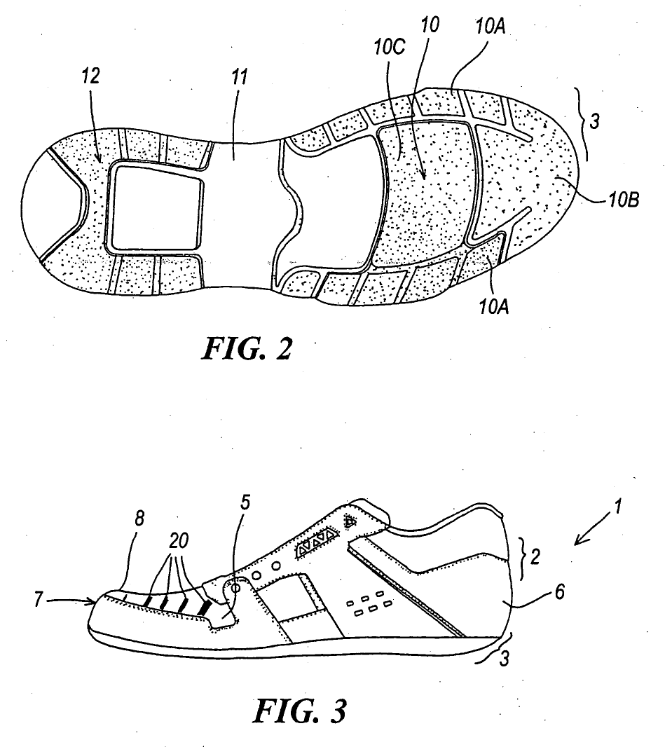

FIG. 2 is a view of the shoe of FIG. 1 seen from below; and

FIG. 3 is a side view of the shoe of FIG. 1.

With reference to said figures, a shoe according to the invention is indicated overall by 1. It comprises a vamp 2 and a sole 3. The vamp comprises side portions 4 and 5, a rear portion 6, a front portion 7 and an upper portion 8 to lie on the foot of the user wearing the shoe. The sole comprises a metatarsal front portion 10 disposed in the metatarsal region of the user's foot, an arched central portion 11 provided at the user's plantar arch, and a heel portion 12 provided at the heel itself.

The vamp can be made of any material such as leather, plastic or part leather-part plastic, while the sole is generally made of plastic material such as EVA.

According to the invention, to improve the surface resistance of at least one portion of said parts 2, 3 of the shoe 1, said portion comprises a very hard non-metallic material offering a corresponding hardness to said portion in order to improve its wear resistance. Said material is mixed with an agent which incorporates it to form a hardening product which can be inserted into or deposited on said vamp and/or sole portion.

Said material has a Vickers hardness of between 5 and 50 GPa and preferably between 10 and 30 GPa. This hardness is obtained by using pulverized ceramic material and, as stated, is incorporated into the binding agent which acts as the matrix for said material. An example of ceramic material is that comprising zirconium oxide: such a material is for example that produced by the SEPR company and marketed under the brand name of Zirduro. An example of the composition of this latter is the following:

| | |
|---|---|
| ZrO₂(+HfO₂) | 32.0% |
| Al₂O₃ | 51.0% |
| Other oxides | 17.0% |
| Metallic iron | 30 ppm |

The binding agent or matrix is for example a polyurethane-based agent such as that known by the brand name “Serink 153-572 Du Cor” produced by Bayer. In a practical embodiment, the ceramic material is present in a quantity of 25% by weight on the product resulting from its mixing with the binding matrix, this latter representing the remaining 75% of product. This matrix contains the polyurethane-based agent (of the aforestated type) together with other materials or additives (for example in a percentage less than 10%) for suitably modifying the density of the binding agent.

Different ceramic materials can evidently be used (such as those containing aluminium, glass or silicon), again in pulverized form, to obtain said product for increasing the hardness of the vamp or sole with which it is associated. In general the percentage of ceramic material on the total product is between 10% and 40% and preferably between 20% and 30%. The average diameter of the particles of pulverized material is between 5 micron and 15 micron, and preferably between 8 and 11 micron.

The hardening product which increases the hardness of the shoe portion is associated with that portion in different ways depending on the type of portion and its constituent material. For example, said product can be associated with the vamp by spray deposition or by brushing it on, particularly if the vamp is of leather. If the vamp is of plastic material or presents plastic portions, the said product can, as an alternative to spraying or brushing, be directly incorporated into said plastic material during the (known) stage in which the vamp is produced. This latter method is mainly used when the hardening product is associated with the sole.

As the shoe presents certain parts more subject to wear than its other parts, said hardening product is advantageously associated with at least part of the side portions of the vamp and with the front portion thereof. For example, the side portions 4 and 5 can be provided with lines of greater hardness (compared with the vamp) obtained with said hardening product. With regard to the sole, the hardening product can be advantageously provided on at least lateral parts 10A of the metatarsal portion 10 of the sole and on the front part 10B of this latter. A central part 10C of said metatarsal portion can also be formed containing the hardening product. Preferably, at least a part of the heel portion 12 of the sole can also present said hardening product.

By virtue of the invention, a long-life shoe can be produced. In this respect, the use of the very hard non-metallic material such as ceramic material confers surface or overall hardness to at least a part of the vamp and/or sole.

The hardening product can be deposited on the surface of said part or incorporated into it, and could also be associated with only discrete regions of that part (such as the aforedescribed lines 20).

1. A shoe (1), in particular a sports shoe, comprising a vamp (2) and a sole (3), said vamp (2) presenting side portions (4, 5), a front portion (7), a rear portion (6) and a portion (8) arranged to lie on the front part of the foot of a user wearing the shoe (1), the sole (3) presenting a metatarsal front portion (10), an arched central portion (11), and a rear heel portion (12), characterised in that at least one among said vamp (2) and said sole (3) presents a part comprising a very hard ceramic material able to confer on said part a high wear resistance and hence a long life.

2. A shoe as claimed in claim 1, characterised in that the ceramic material is incorporated into a binding material such as to define a hardening product.

3. A shoe as claimed in claim 2, characterised in that the hardening product is deposited on the surface of at least one part of the vamp (2).

4. A shoe as claimed in claim 3, characterised in that the hardening product is deposited in discrete regions of the part of the vamp (2).

5. A shoe as claimed in claim 4, characterised in that the hardening product defines discrete lines (20) on said part of the vamp (2).

6. A shoe as claimed in claim 2, characterised in that the hardening product is incorporated into a part of the vamp (2) and/or a part of the sole (3).

7. A shoe as claimed in claim 1, characterised in that that part of the vamp (2) comprising the ceramic material is at least one among its side portions (4, 5), its rear portion (6) and its front portion (7).

8. A shoe as claimed in claim 1, characterised in that that part of the sole (3) comprising the ceramic material is at least one among the metatarsal portion (10) and the heel portion (12).

9. A shoe as claimed in claim 8, characterised in that that part of the metatarsal portion (10) of the sole (3) comprising the ceramic material is at least one among the lateral parts (10A), the front part (10B) and the central part (10C) of said portion.

10. A shoe as claimed in claim 2, characterised in that the ceramic material is present in a percentage between 10% and 45% of the weight of the hardening product.

11. A shoe as claimed in claim 10, characterised in that the percentage of ceramic material is between 20% and 30% of the weight of the hardening product.

12. A shoe as claimed in claim 1, characterised in that the ceramic material used is in the form of powder with an average particle diameter between 5 and 15 micron, and preferably between 8 and 11 micron.

13. A shoe as claimed in claim 1, characterised in that the ceramic material used contains at least one of the following components: zirconium, aluminium, glass, silicon.

14. A shoe as claimed in claim 1, characterised in that the ceramic material has a Vickers hardness between 5 and 50 GPa and preferably between 10 and 30 GPa.

15. A hardening product for use in a shoe of the type comprising a vamp (2) and a sole (3) in order to confer wear resistance on at least a part of these latter, said product being characterised by comprising a ceramic material.

16. A hardening product as claimed in claim 15, characterised in that the ceramic material contains at least one of the following components: zirconium, aluminium, glass, silicon.

17. A hardening product as claimed in claim 15, characterised in that the ceramic material is incorporated into a matrix of a binding agent.

18. A hardening product as claimed in claim 17, characterised in that the binding agent is a polyurethane-based substance.

19. A product as claimed in claim 15, characterised in that said ceramic hardening material is originally a powder with a particle size between 5 and 15 micron and preferably between 8 and 11 micron.

20. A shoe vamp comprising side portions (4, 5), a front portion (7), a rear portion (6) and an upper portion (8) arranged to lie on a foot of a user wearing the shoe, characterised in that at least a part of at least one of said portions (4, 5, 6, 7, 8) comprises a ceramic material.

21. A vamp as claimed in claim 19, characterised in that the ceramic material is incorporated into a binding matrix and defines therewith a hardening product.

22. A vamp as claimed in claim 20, characterised in that the hardening product is on the vamp surface.

23. A vamp as claimed in claim 21, characterised in that the hardening product defines discrete regions (20) of the vamp.

24. A vamp as claimed in claim 20, characterised in that the hardening product is incorporated into the vamp (2).

25. A shoe sole comprising a front metatarsal portion (10), an arched portion (11) and a heel portion (12), characterised in that at least a part of at least one of said portions (10, 11, 12) comprises a ceramic material.

26. A shoe sole as claimed in claim 24, characterised in that the ceramic material is present in at least one part among the lateral parts (10A), the front part (10B) and the central part (10B) of the metatarsal portion.

27. A shoe sole as claimed in claim 24, characterised in that the ceramic material is incorporated into a binding matrix and defines therewith a hardening product.

28. A shoe sole as claimed in claim 26, characterised in that the ceramic material is at least one chosen from the following components: zirconium, aluminium, glass, silicon.

29. A shoe sole as claimed in claim 26, characterised in that the binding agent of the binding matrix is a polyurethane-based product.

30. A shoe sole as claimed in claim 26, characterised in that the hardening product is incorporated into the sole material.
